(19) United States
(12) Patent Application Publication
(10) Pub. No.: US 2014/0278456 A1
(43) Pub. Date: Sep. 18, 2014

(54) DETERMINING INCREASED REIMBURSEMENTS RESULTING FROM AN INCREASE IN A REIMBURSEMENT PARAMETER ASSOCIATED WITH A HEALTHCARE PRODUCT

(71) Applicant: MCKESSON CORPORATION, San Francisco, CA (US)

(72) Inventors: Rudy D. Milosevich, Columbus, OH (US); Sheila D. Miller, Grayson, GA (US)

(73) Assignee: MCKESSON CORPORATION, San Francisco, CA (US)

(21) Appl. No.: 13/804,175

(22) Filed: Mar. 14, 2013

(51) Int. Cl. G06F 19/00

(52) U.S. Cl. CPC G06F 19/328
USPC 705/2

(57) ABSTRACT

Systems, methods, and computer-readable media for performing filtering and selection processing to identify, from among healthcare products associated with increases in reimbursement rates for a reimbursement parameter, those products that are candidates for valuation processing, and for performing valuation processing for the candidate healthcare products. The valuation processing may include determining a value indicative of total increased reimbursements associated with a candidate healthcare product.

### CROSS-REFERENCE TO RELATED APPLICATION(S)

This disclosure is related to U.S. application Ser. No. 13/782,909, filed on Mar. 1, 2013.

### FIELD OF THE DISCLOSURE

This disclosure relates generally to healthcare claim transactions, and more particularly, to determining an increase in reimbursements resulting from increased reimbursement levels.

### BACKGROUND

When an insured patient fills a prescription at a retail pharmacy, for example, the pharmacy generates a healthcare claim transaction that is communicated to a claims processor system for adjudication, typically via one or more intermediate service provider systems. The pharmacy is typically reimbursed for the healthcare claim transaction at an amount set by the public or private insurance entity under which the patient is insured or by a Pharmacy Benefit Manager (PBM) administering the insured patient's drug plan on behalf of the public or private insurance entity. PBMs typically designate a threshold value referred to as the Maximum Allowable Cost or Maximum Allowable Charge (MAC) that represents an upper limit at which a healthcare claim transaction for a particular healthcare product or service will be reimbursed. MAC rates are typically independently set by a PBM and may be increased by the PBM responsive to a variety of factors. When a PBM decides to raise the MAC reimbursement rate for healthcare claim transactions associated with a healthcare product that has been dispensed, the healthcare provider that dispensed the product (e.g., a pharmacy) is often unaware of the increased MAC reimbursement rate and/or is poorly equipped to calculate the increase in reimbursement revenue resulting from the increased MAC reimbursement rate.

### BRIEF DESCRIPTION OF THE DRAWINGS

The detailed description is set forth through reference to the accompanying drawings. In the drawings, the left-most digit(s) of a reference numeral identifies the drawing in which the reference numeral first appears. The use of the same reference numerals indicates similar or identical items; however, similar or identical items may also be designated with different reference numerals. Various embodiments may utilize element(s) and/or component(s) other than those illustrated in the drawings, and some element(s) and/or component(s) may not be present in various embodiments. A description of a component or element using singular terminology may, depending on the context, encompass a plural number of such components or elements and vice versa.

FIG. 1 depicts an illustrative system architecture for reimbursement valuation in accordance with one or more embodiments of the disclosure.

FIG. 2 is a process flow diagram of an illustrative method of determining an increase in total reimbursements for a candidate healthcare product associated with a reimbursement parameter that has been increased in accordance with one or more embodiments of the disclosure.

FIG. 3 is a process flow diagram of an illustrative method for determining whether a healthcare product associated with an increased reimbursement parameter is a candidate for reimbursement valuation and for performing processing associated with the reimbursement valuation in accordance with one or more embodiments of the disclosure.

FIG. 4 is a process flow diagram of an illustrative method for determining a total loss of additional reimbursement for a healthcare transaction reimbursed at an alternate rate subsequent to an increase in a reimbursement parameter associated with a healthcare product in accordance with one or more embodiments of the disclosure.

### DETAILED DESCRIPTION OF EMBODIMENTS OF THE DISCLOSURE

### Overview

Embodiments of the disclosure relate to, among other things, systems, methods, computer-readable media, techniques, and methodologies for analyzing healthcare claim transaction data to identify one or more healthcare products that are candidates for reimbursement valuation and performing valuation processing to determine, for each candidate healthcare product, a value indicative of an increase in reimbursements for healthcare claim transactions associated with the candidate healthcare product.

In accordance with one or more embodiments of the disclosure, a reimbursement valuation system may be provided that includes one or more reimbursement valuation computers. A reimbursement valuation application may be provided that is executable on one or more of the reimbursement valuation computer(s). The reimbursement valuation application may be configured to present one or more user interfaces to a user via which the user may provide input and receive a presentation of output. The reimbursement valuation application may include various program modules or engines such as, for example, a filtering and selecting engine and a valuation engine. The filtering and selection engine may include computer-executable instructions that responsive to execution by one or more processors associated with the reimbursement valuation system causes filtering and selection processing to be performed for identifying healthcare product(s) that are candidates for reimbursement valuation. The valuation engine may include computer-executable instructions that responsive to execution by one or more processors associated with the reimbursement valuation system causes valuation processing to be performed in connection with the identified candidate healthcare product(s).

The filtering and selection engine and/or the valuation engine may utilize various data in performing the filtering and selecting processing and the valuation processing such as, for example, reimbursement review data and healthcare claim transaction data. The healthcare claim transaction data may include data relating to healthcare transactions associated with one or more healthcare products. The healthcare transactions may include transactions generated by a healthcare provider and adjudicated by a claims processor over some period of time. The reimbursement review data may include data that indicates the results of reimbursement reviews conducted by various claim processors in response to requests submitted on behalf of healthcare providers for increases in reimbursement rates for a reimbursement parameter associated with healthcare products.

While embodiments of the disclosure may be described in the context of a healthcare provider that is a pharmacy, it should be appreciated that the healthcare provider may be any suitable healthcare provider including, but not limited to, a pharmacy, a prescriber, another drug distributor or drug dispensing entity, and so forth. The claims processor may be a public or private insurance entity offering an insurance product or plan under which the patient is insured or an entity operating on behalf of such a public or private insurance entity such as a Pharmacy Benefits Manager (PBM). While certain embodiments of the disclosure may be described in the context of a claims processor that is a PBM, it should be appreciated that the claims processor may be any suitable entity that adjudicates healthcare transactions including, but not limited to, any private payor, any public payor such as a government payor, a claims clearinghouse, and so forth. In addition, the healthcare product may be any suitable product or service for which reimbursement may be sought by a healthcare provider from a claims processor or other insuring entity. For example, the healthcare product may be a branded or generic prescription product, a non-prescription product, a healthcare service, and so forth.

As a non-limiting example, the reimbursement parameter described above may be a MAC rate. The reimbursement review data may indicate, for each healthcare product for which a request to increase an associated MAC rate was submitted, whether the claims processor decided to: (i) increase the MAC rate (and if this is the case, potentially the increased MAC rate), (ii) utilize an increased rate associated with a different reimbursement parameter (e.g., a contracted rate), or (iii) maintain the present MAC rate. A healthcare product that is a candidate for requesting an increase in an associated MAC rate may be identified in accordance with any suitable technique or methodology. For example, a candidate healthcare product for requesting an increase in a MAC rate may be a product with associated healthcare claim transactions reimbursed at a MAC rate below an acquisition cost of the product. In certain scenarios, a determination may need to be made that a selection parameter indicative of an amount of loss associated with reimbursement at a MAC rate below cost satisfies an associated threshold prior to identifying the healthcare product as a candidate for requesting an increase in the MAC rate. In certain embodiments, the reimbursement valuation system may be configured to identify a healthcare product that is a candidate for requesting an increase in an associated MAC rate, while in other embodiments, one or more other systems may be provided for performing processing to identify healthcare product(s) that are candidates for requesting increases in MAC rates.

In accordance with one or more embodiments of the disclosure, the filtering and selection engine may be configured to analyze the reimbursement review data to identify one or more healthcare products associated with respective MAC rates that were increased from a first respective rate to a second respective rate. The MAC rates may have been increased by a claims processor responsive to requests, submitted on behalf of various healthcare providers, for increasing the MAC rates. It should be appreciated that while embodiments of the disclosure may be described in the context of MAC rates, such embodiments are equally applicable to any suitable reimbursement parameter.

As part of identifying the one or more healthcare products associated with increased MAC rates, the filtering and selection engine may be configured to identify a particular time frame and analyze the reimbursement review data to identify those healthcare product(s) for which the MAC rate was increased within the identified time frame. A determination may be made that a MAC rate increase occurred within a particular time frame based at least in part on receipt, within the time frame, of an indication from a claims processor that the MAC rate has been increased. For example, a time/date stamp or other identifier may be associated with the indication of the increase in the MAC rate. The time frame may be any suitable time frame including, but not limited to, any number of days, weeks, months, etc.

Upon identification of the one or more healthcare products associated with MAC rates that were increased during a particular time frame, the filtering and selection engine may be configured to access the healthcare claim transaction data and retrieve respective healthcare claim transactions associated with each healthcare product associated with an increased MAC rate. The respective healthcare claim transactions may include a respective first set of healthcare claim transactions associated with a designated first period of time prior to the MAC rate increase and a respective second set of healthcare claim transactions associated with a designated second period of time subsequent to the MAC rate increase. The first and second periods of time may be of a same duration or of different durations. The first and second periods of time may be identified based at least in part on user input received from a user of the reimbursement valuation application. In certain embodiments, the respective first and second sets of healthcare transactions may include those healthcare transactions adjudicated by the claims processor that increased the MAC rate for the healthcare product.

Upon identification of the respective first and second sets of healthcare claim transactions for each healthcare product associated with an increased MAC rate, the filtering and selection engine may be configured to perform processing to identify those healthcare products that are candidates for reimbursement valuation. For ease of explanation, the processing for identifying candidate healthcare products for reimbursement valuation will be described hereinafter through reference to a single healthcare product associated with an increased MAC rate.

In certain embodiments, as part of the filtering and selection processing, any healthcare claim transactions reimbursed at a Usual and Customary rate may be filtered from the first set of healthcare claim transactions. Further, any transactions reimbursed at a contracted rate or an Ingredient Cost Submitted rate may be filtered out as well. Upon filtering out such transactions, a determination may be made as to whether any healthcare transaction remains in the first set. If no transactions remain in the first set, a determination may be made as to whether the second set of healthcare claim transactions includes any healthcare transaction(s) reimbursed at the increased MAC reimbursement rate. If no such transaction is present in the second set, a determination may be made that the healthcare product is not a suitable candidate for reimbursement valuation because sufficient claim transaction data is not available for quantifying an increase in reimbursements resulting from the increased MAC rate.

On the other hand, if no transaction remains in the first set upon performing the filtering described above, and if the second set includes a transaction reimbursed at the increased MAC rate, a reimbursement amount associated with a representative healthcare transaction may be used to calculate, at least in part, an increase in reimbursements resulting from the increased MAC rate as part of the valuation processing described in more detail hereinafter. The representative healthcare claim transaction may be a transaction that was selected for use in requesting the increase in the MAC rate. In certain embodiments, if no transaction remains in the first set upon performing the filtering described above, a determination may need to be made that the second set includes a threshold number of transactions reimbursed at the increased MAC rate prior to performing the valuation processing for the healthcare product.

In other embodiments, one or more healthcare claim transactions reimbursed at a MAC rate below cost may be identified from the first set. In certain embodiments, if the number of healthcare transactions reimbursed below cost in the first set does not satisfy an associated threshold, it may be determined that the healthcare product is not a suitable candidate for reimbursement valuation. That is, if the reimbursement below cost is not widespread prior to the increase in the MAC rate (as determined based on an associated threshold), the healthcare product may be determined not to be a suitable candidate for reimbursement valuation. Upon identifying healthcare claim transactions in the first set that were reimbursed below cost (and potentially determining that the number of such transactions satisfies an associated threshold), a determination may be made as to whether the second set includes any healthcare claim transactions reimbursed at the increased MAC rate. If no such transactions exist, the healthcare product may be determined not to be a suitable candidate for reimbursement valuation because quantifying an increase in reimbursements due to the increase in the MAC rate of the product may not be possible.

On the other hand, if the second set does include transactions reimbursed at the increased MAC rate, the healthcare product may be determined to be a suitable candidate for reimbursement valuation, and the valuation engine may be configured to perform valuation processing to determine a total increase in reimbursements as a result of the increased MAC rate. The valuation processing may include determining a metric indicative of a per-unit reimbursement amount for each healthcare transaction in the first set that was reimbursed at a MAC rate below cost. The metric may be, but is not limited to, an average of the per-unit reimbursement amounts for each of the healthcare transactions in the first set that were reimbursed below cost.

The valuation processing may further include iterating through each claim transaction in the second set that was reimbursed in accordance with the increased MAC rate. For each such claim transaction, the average per-unit reimbursement amount for the healthcare transactions from the first set that were reimbursed below cost may be subtracted from the reimbursement amount of a selected transaction from the second set that was reimbursed in accordance with the increased MAC rate to generate a value indicative of a per-unit reimbursement increase. This value may then be multiplied by the number of units dispensed to generate a value indicative of the total increased reimbursement for the selected healthcare transaction from the second set. This valuation processing may be repeated for each healthcare claim transaction from the second set that is reimbursed at a reimbursement amount in accordance with the increased MAC rate in order to generate a value indicative of the total increased reimbursement for the healthcare product.

Information indicative of the results of the valuation processing (e.g., the total increased reimbursement, the number of claims affected, etc.) may be stored in one or more datastores. As previously noted, the filtering and selection processing for determining a candidate healthcare product for reimbursement valuation and the associated valuation processing may be specific to particular healthcare providers. That is, the value indicative of the total increased reimbursement for a healthcare product may be based on those healthcare transactions associated with a particular healthcare provider. Accordingly, the information generated as a result of the valuation processing may be communicated to an appropriate healthcare provider in order to demonstrate to the healthcare provider the increase in reimbursements that followed after a reimbursement parameter (e.g., MAC rate) associated with the healthcare product was increased responsive to a request for the increase. In this manner, the healthcare provider will be made aware of the extent of the increase in reimbursements resulting from efforts to increase the MAC rate of a healthcare product.

The above description of the disclosure is merely illustrative and numerous other embodiments are within the scope of this disclosure. The embodiments described above as well as additional embodiments will be described in greater detail below.

### Illustrative Architecture

FIG. 1 depicts an illustrative system architecture 100 for reimbursement valuation in accordance with one or more embodiments of the disclosure. As depicted in FIG. 1, the system architecture 100 may include one or more reimbursement valuation computers 102, one or more healthcare provider computers 104, one or more service provider computers 106, and one or more claims processor computers 108. While various components of the illustrative architecture (e.g., the reimbursement valuation computer 102) may be referred to herein in the singular, it should be appreciated that, depending on the context, a plural number of such components may be provided. Further, one or more of the healthcare provider computer(s) 104 may be associated with a respective healthcare provider (e.g., a pharmacy, a prescriber, etc.), and one or more of the claims processor computer(s) 108 may be associated with a respective claims processor (e.g., a PBM, a private insurer, a public insurer such as a government insurer, a private or public payor, a claims clearinghouse, etc.). Further, any functionality described herein as being supported by the reimbursement valuation computer 102 may, in various embodiments, be supported by a reimbursement valuation system that includes one or more reimbursement valuation computers 102. Accordingly, the terms reimbursement valuation computer 102 and reimbursement valuation system 102 may be used interchangeably herein. The same may hold true for any other components of the illustrative system architecture 100 (e.g., the healthcare provider computer 104, the service provider computer 106, and the claims processor computer 108).

As desired, the reimbursement valuation computer 102, the healthcare provider computer 104, the service provider computer 106, and/or the claims processor computer 108 may include one or more processing devices that may be configured to access and read computer-readable media having stored thereon computer-executable instructions for implementing various functionality described herein and data manipulated or generated by the execution of such computer-executable instructions. Each of the reimbursement valuation computer 102, the healthcare provider computer 104, the service provider computer 106, and/or the claims processor computer 108 may include networked devices or systems that include or are otherwise associated with suitable hardware and/or software components for transmitting and receiving data and/or computer-executable instructions over one or more communications links or networks. These networked devices and systems may include any number of processors for processing data and executing computer-executable instructions, as well as other internal and peripheral components. Further, these networked devices and systems may include or be in communication with any number of suitable memory devices operable to store data and/or computer-executable instructions. By storing and/or executing computer-executable instructions, each of the networked devices may form a special purpose computer or a particular machine.

As depicted in FIG. 1, the reimbursement valuation computer 102, the healthcare provider computer 104, the service provider computer 106, and/or the claims processor computer 108 may be configured to communicate via one or more networks, such as the network(s) 110, which may include one or more separate or shared private and/or public networks. The network(s) 110 may include, but are not limited to, any one or a combination of different types of suitable communications networks, such as cable networks, the Internet, wireless networks, cellular networks, or any other private and/or public networks. Further, the network(s) 110 may include any type of medium over which network traffic may be transmitted including, but not limited to, coaxial cable, twisted-pair wire, optical fiber, hybrid fiber coaxial (HFC), microwave terrestrial transceivers, radio frequency communications, or satellite communications.

The network(s) 110 may allow for information to be transmitted between or among the reimbursement valuation computer 102, the healthcare provider computer 104, the service provider computer 106, and/or the claims processor computer 108 in a real-time, off-line, and/or batch processing manner. In one or more embodiments, the illustrative system architecture 100 may be implemented in the context of a distributed computing environment. Further, it should be appreciated that the illustrative system architecture 100 may be implemented in accordance with any suitable network configuration. For example, the network(s) 110 may include a plurality of networks, each with devices such as gateways, routers, linked-layer switches, and so forth for providing connectivity between or among the various devices forming part of the system architecture 100. In some embodiments, dedicated communication links may be used to connect the various devices of the system architecture 100. For example, one or more of the service provider computers 106 may serve as a network hub that interconnects the healthcare provider computer 104 and the claims processor computer 108.

The one or more healthcare provider computers 104 may be associated with various types of healthcare providers. For example, one or more of the healthcare provider computers 104 may be associated with an entity (e.g., a pharmacy or pharmacy chain) authorized to dispense medical products and/or provide certain healthcare-related services to patients. Additionally, or alternatively, one or more of the healthcare provider computers 104 may be associated with a prescribing healthcare provider, such as a physician, a hospital, and so forth. The healthcare provider computer 104 may include any suitable processor-driven device that facilitates the generation and processing of healthcare claim transactions or any other healthcare-related transactions.

In one or more embodiments, the healthcare provider computer 104 may be configured to communicate information associated with healthcare claim transactions to the service provider computer 106. In certain embodiments, the healthcare provider computer 104 may be any suitable computing device associated with a healthcare provider, such as a point-of-sale device or a pharmacy management computer associated with a pharmacy, a practice management computer associated with a physician's office, clinic or hospital, and so forth. By storing and/or executing computer-executable instructions, the healthcare provider computer 104 may form a special purpose computer or other particular machine that is operable to facilitate the processing of healthcare requests submitted by patients in order to generate healthcare claim transactions based on the healthcare requests and to transmit the generated healthcare claim transactions to the service provider computer 106. In certain embodiments of the disclosure, operations performed by the healthcare provider computer 104 may be distributed among several processing components.

According to one or more illustrative embodiments of the disclosure, a healthcare claim transaction generated by the healthcare provider computer 104 and received by the service provider computer 106 may be formatted in accordance with a version of a National Council for Prescription Drug Programs (NCPDP) Telecommunication Standard, although other standards may be utilized as well. The healthcare claim transaction may include a Bank Identification Number (BIN) and/or a Processor Control Number (PCN) for identifying a particular claims processor computer or payor, such as the claims processor computer 108, as an intended recipient of the transaction. In addition, the healthcare claim transaction may include information identifying a patient, a payor (e.g., a PBM), a prescriber, a healthcare provider, and/or the healthcare product to which the transaction relates.

Upon receipt of a healthcare claim transaction from the healthcare provider computer 104, the service provider computer 106 may be configured to process the transaction in any suitable manner including performing various pre-edits to the transaction and/or making any of a variety of determinations with respect thereto. The pre-edits that may be performed may involve verifying, adding, and/or editing information included in the healthcare claim transaction. Processing of the healthcare claim transaction by the service provider computer 106 may result in any of a variety of further communication with the healthcare provider computer 104 prior to routing of the transactions to the claims processor computer 108.

According to one or more embodiments of the disclosure, upon determining that the healthcare claim transaction is appropriate for routing, the service provider computer 106 may utilize at least a portion of the information included in the transaction, such as, for instance, a BIN/PCN, to determine the appropriate claims processor computer 108 to which to route the transaction. The service provider computer 106 may also utilize a routing table, perhaps stored in memory, to determine the network location of the appropriate claims processor computer 108.

The claims processor computer 108 may receive, adjudicate, and/or otherwise process the healthcare claim transaction received from the service provider computer 106. For example, the claims processor computer 108 may perform an adjudication process for determining benefits coverage with respect to eligibility, pricing, and/or utilization review. The adjudication process may involve determining whether the patient associated with the healthcare claim transaction is eligible for reimbursement for the dispensed healthcare product under the patient's insurance plan, and if so, the amount of the claim that will be reimbursed. The claims processor computer 108 may then communicate an adjudicated response to the service provider computer 106.

The healthcare claim transaction routed to the claims processor computer 108 from the healthcare provider computer 104 via the service provider computer 106 may take the form of an adjudication request data segment. The adjudication response from the claims processor computer 108 may take the form of an adjudication response data segment including information identifying the eligibility determination and the reimbursement amount that is appended to the request data segment. The claims processor computer 108 may communicate a combined data packet including both the adjudication request data segment and the adjudication response data segment to the service provider computer 106.

As desired, upon receipt of the adjudication response from the claims processor computer 108, the service provider computer 106 may perform any number of post-edits on the adjudicated response. The adjudicated response may then be routed or otherwise communicated by the service provider computer 106 to the healthcare provider computer 104.

The illustrative system architecture 100 may further include a reimbursement valuation system that comprises one or more reimbursement valuation computers 102. While the following discussion may be presented through reference to a reimbursement valuation computer 102, it should be appreciated that the discussion is intended to encompass a reimbursement valuation system that includes one or more of the reimbursement valuation computers 102 and any of a variety of other hardware, software, or firmware system components. The reimbursement valuation computer 102 may be configured to access and retrieve data from one or more datastores such as healthcare claim transaction data from datastore(s) 136 and reimbursement review data from datastore(s) 138. The healthcare claim transaction data may include data relating to adjudicated healthcare claim transactions associated with a variety of healthcare providers and claims processors and may be harvested from a variety of healthcare provider computers 104 and transmitted to the reimbursement valuation computer 102 via one or more of the network(s) 110 in data streams received on a batch and/or real-time basis. Alternatively, or additionally, the healthcare claim transaction data may be gathered from a variety of healthcare providers and may be stored in one or more shared datastores accessible by the reimbursement valuation computer 102. In certain embodiments, the healthcare claim transaction data may be received as one or more data files according to any suitable file format. However, embodiments of the disclosure are not so limited, and the healthcare claim transaction data may be accessed or received by the reimbursement valuation computer 102 in any suitable form or format and according to any suitable mechanism.

The reimbursement valuation computer 102 may additionally be configured to access and retrieve reimbursement review data from one or more datastores 138. The reimbursement review data may include data that indicates the results of reimbursement reviews conducted by various claims processors in response to requests submitted on behalf of healthcare providers for increases in reimbursement rates for a reimbursement parameter associated with healthcare products. The reimbursement parameter may be, but is not limited to, a MAC rate associated with the healthcare product. As a non-limiting example, the reimbursement review data may indicate, for each healthcare product for which a request to increase an associated MAC rate was submitted, whether the claims processor decided to: (i) increase the MAC rate (and if this is the case, potentially the increased MAC rate), (ii) utilize an increased rate associated with a different reimbursement parameter (e.g., a contracted rate), or (iii) maintain the MAC rate. A healthcare product that is a candidate for requesting an increase in an associated MAC rate may be identified in accordance with any suitable technique or methodology. For example, a candidate healthcare product for requesting an increase in a MAC rate may be a product with associated healthcare claim transactions reimbursed at a MAC rate below an acquisition cost of the product. In certain scenarios, a determination may need to be made that a selection parameter indicative of an amount of loss associated with reimbursement at a MAC rate below cost satisfies an associated threshold prior to identifying the healthcare product as a candidate for requesting an increase in the MAC rate. In certain embodiments, the reimbursement valuation computer 102 may be configured to perform filtering and selection processing to identify a healthcare product that is a candidate for requesting an increase in an associated MAC rate, while in other embodiments, one or more other systems may be provided for performing the filtering and selection processing.

Referring again to the reimbursement valuation computer 102, the computer 102 may include one or more memory devices 114 (generically referred to herein as memory 114), one or more processors 112 configured to execute computer-executable instructions that may be stored in the memory 114, one or more input/output (“I/O”) interface(s) 130, data storage 132, and/or one or more network interface(s) 134. The reimbursement valuation computer 102 may be any suitable processor-driven device including, but not limited to, a server, a desktop computer, a mobile computing device, a mainframe computer, and so forth. The processor(s) 112 may include any suitable processing unit capable of accepting digital data as input, processing the input data in accordance with stored computer-executable instructions, and generating output data. The processor(s) 112 may be configured to execute the computer-executable instructions to cause or facilitate the performance of various operations. The processor(s) 112 may include any type of suitable processing unit including, but not limited to, a central processing unit, a microprocessor, a Reduced Instruction Set Computer (RISC), a Complex Instruction Set Computer (CISC), a microprocessor, a microcontroller, an Application Specific Integrated Circuit (ASIC), a Field-Programmable Gate Array (FPGA), a System-on-a-Chip (SoC), and so forth.

The memory 114 may store computer-executable instructions that are loadable and executable by the processor(s) 112, as well as data manipulated and/or generated by the processor(s) 112 during the execution of the computer-executable instructions. The memory 114 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 114 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The memory 114 may store data, computer-executable instructions, and/or various program modules including, for example, a database management system (DBMS) 118, one or more operating systems (0/S) 116, and/or a reimbursement valuation application 120. The (0/S) 116 may provide an interface between other application software executing on the reimbursement valuation computer 102 and the hardware resources of the reimbursement valuation computer 102. More specifically, the O/S 116 may include a set of computer-executable instructions for managing hardware resources of the reimbursement valuation computer 102 and for providing common services to other application programs (e.g., managing memory allocation among various application programs). The O/S 116 may include any operating system now known or which may be developed in the future including, but not limited to, a Microsoft Windows® operating system, an Apple OSX™ operating system, Linux, Unix, a mainframe operating system such as Z/OS, a mobile operating system, or any other proprietary or freely available operating system.

The DBMS 118 may support functionality for accessing, retrieving, storing, and/or manipulating data stored in one or more datastores (e.g., the datastore(s) 136, 138). The DBMS 118 may use any of a variety of database models (e.g., relational model, object model, etc.) and may support any of a variety of query languages.

The one or more I/O interfaces 130 may facilitate receipt by the reimbursement valuation computer 102 of information input from one or more I/O devices as well as the output of information from the reimbursement valuation computer 102 to the one or more I/O devices. The I/O devices may include, for example, one or more user interface devices that facilitate interaction between a user and the reimbursement valuation computer 102 including, but not limited to, a display, a keypad, a control panel, a touch screen display, a remote control device, a microphone, and so forth. As a non-limiting example, the one or more I/O interfaces 130 may facilitate interaction between a user and the reimbursement valuation application 120 to facilitate performance of filtering, selection, and valuation processing.

The reimbursement valuation computer 102 may also include data storage 132 such as removable storage and/or non-removable storage including, but not limited to, magnetic storage, optical disk storage, and/or tape storage. Data storage 132 may provide storage of computer-executable instructions and other data. The data storage 132 may include storage that is internal and/or external to the reimbursement valuation computer 102. The memory 114 and/or the data storage 132, removable and/or non-removable, are all examples of computer-readable storage media (CRSM).

The reimbursement valuation computer 102 may further include one or more network interfaces 134 that may facilitate communication between the reimbursement valuation computer 102 and other devices within the networked system architecture 100 via one or more of the network(s) 110.

The operations of the reimbursement valuation computer 102 may be controlled upon execution of computer-executable or computer-implemented instructions by the one or more processors 112 associated with the reimbursement valuation computer 102 to form a special purpose computer or other particular machine. The one or more processors 112 that control the operations of the reimbursement valuation computer 102 may be incorporated into the reimbursement valuation computer 102 or may be in communication with the reimbursement valuation computer 102 via one or more suitable networks (e.g., one or more of the network(s) 110). In certain embodiments of the disclosure, the operations and/or control of the reimbursement valuation computer 102 may be distributed among several processing components.

While not described in detail, it should be appreciated that the healthcare provider computer 104, the service provider computer 106, and the claims processor computer 108 may include any software, hardware, and/or firmware for supporting the respective functionality of each of the devices including any of the components described with respect to the reimbursement valuation computer 102.

For example, the healthcare provider computer 104 may include any suitable software, hardware, and/or firmware components for processing healthcare requests submitted by patients in order to generate healthcare claim transactions based on the healthcare requests, for transmitting the generated healthcare claim transactions to the service provider computer 106 for routing to an intended recipient (e.g. the claims processor computer 108), and for receiving adjudicated responses from the claims processor computer 108 via the service provider computer 106.

The service provider computer 106 may include any suitable software, hardware, and/or firmware for processing a healthcare claim transaction received from a healthcare provider computer 104. The processing may include performing various pre-edits to the transaction and/or making any of variety of determinations with respect thereto. The pre-edits that may be performed may involve verifying, adding, and/or editing information included in the healthcare claim transaction. The service provider computer 106 may further include any suitable software, hardware, and/or firmware components for identifying an appropriate recipient (e.g., an appropriate claims processor computer 108) to which to route the healthcare transaction, routing the transaction to the appropriate recipient, receiving an adjudicated response thereto, performing any desired post-edit processing on the adjudicated response, and transmitting the adjudicated response to an appropriate healthcare provider computer 104.

The claims processor computer 108 may include any suitable software, hardware, and/or firmware components that support receipt, adjudication, and other processing of the healthcare claim transaction received from the service provider computer 106 and transmission of an adjudicated response to the service provider computer 106.

Referring again to the reimbursement valuation computer 102, a reimbursement valuation application 120 may be loaded into the memory 114 and executable by the processor(s) 112. The reimbursement valuation application 120 may include computer-executable instructions that responsive to execution by the processor(s) 112 cause various filtering and selection processing and valuation processing to be performed in accordance with one or more embodiments of the disclosure. The reimbursement valuation application 120 may include various sub-modules or engines such as, for example, a filtering and selection engine 122 and a valuation engine 124. The filtering and selection engine 122 may include computer-executable instructions executable by the processor(s) 112 to perform various filtering and selection processing to identify healthcare products that are candidates for reimbursement valuation. The filtering and selection engine 122 may utilize various data as part of the filtering and selection processing including, but not limited to, valuation timeframe data 126 and/or valuation threshold data 128. The valuation engine 124 may include computer-executable instructions executable by the processor(s) 112 to perform valuation processing on candidate healthcare products to generate values indicative of total increased reimbursements resulting from an increase in a reimbursement parameter associated with the candidate healthcare products. It should be appreciated that, in certain embodiments, the various functionality supported by the reimbursement valuation application 120 and the various sub-modules and engines included therein may be performed, at least in part, responsive to input received from a user via one or more user interfaces associated with the reimbursement valuation application 120. Such functionality will be described in more detail through reference to the illustrative methods of FIGS. 2-4.

Those of ordinary skill in the art will appreciate that any of the components of the system architecture 100 may include alternate and/or additional hardware, software, or firmware components beyond those described or depicted without departing from the scope of the disclosure. More particularly, it should be appreciated that software, firmware, or hardware components depicted or described as forming part of any of the reimbursement valuation computer 102, the healthcare provider computer 104, the service provider computer 106, and/or the claims processor 108 computer, and the associated functionality that such components support, are merely illustrative and that some components may not be present or additional components may be provided in various embodiments. While various program modules (e.g., the reimbursement valuation application 120 or the sub-modules included therein such as the filtering and selection engine 122 and the valuation engine 124) have been depicted and described with respect to various illustrative components of the system architecture 100, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of the software, firmware, and/or hardware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative networked system architecture 100 depicted in FIG. 1 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system architecture 100 depicted in FIG. 1, or additional functionality.

### Illustrative Processes

FIG. 2 is a process flow diagram of an illustrative method 200 for determining an increase in total reimbursements for a candidate healthcare product associated with a reimbursement parameter that has been increased in accordance with one or more embodiments of the disclosure. According to one or more embodiments of the disclosure, the functionality for performing one or more of the operations of the illustrative method 200 may be supported by the reimbursement valuation computer 102, or more specifically, the reimbursement valuation application 120 or sub-modules included therein such as the filtering and selection engine 122 and/or the valuation engine 124.

At block 202, a healthcare product that is associated with a reimbursement parameter that has been increased may be identified. Computer-executable instructions provided as part of the filtering and selection engine 122 may be executed to analyze reimbursement review data retrieved from the datastore(s) 138 to identify the healthcare product. The reimbursement parameter that has been increased may be a MAC rate associated with the healthcare product. The MAC rate may have been increased by a claims processor (e.g., a PBM) responsive to a request for an increase in the MAC rate. Alternatively, the healthcare product that is identified may be associated with a decision by the claims processor to cease reimbursement for the healthcare product in accordance with a particular reimbursement parameter (e.g., the MAC rate) and initiate reimbursement in accordance with a different reimbursement parameter (e.g., a contracted rate). The identification of the healthcare product may be based at least in part on at least a portion of the valuation timeframe data 126. For example, the filtering and selection engine 122 may be configured to identify a particular time period from the valuation timeframe data 126, and identify those healthcare products associated with an increase in a reimbursement parameter that occurred in the identified time period.

At block 204, a determination may be made that the healthcare product is a candidate for reimbursement valuation. For example, computer-executable instructions provided as part of the filtering and selection engine 122 may, responsive to execution by the processor(s) 112, perform various filtering and selection processing, based on at least portions of the valuation timeframe data 126 and/or the valuation threshold data 128, to determine that the healthcare product is a candidate for reimbursement valuation. The filtering and selection processing that may be performed at block 204 will be described in more detail through reference to the illustrative method depicted in FIG. 3. In certain embodiments, multiple different healthcare products may be identified at block 202 and only a portion of those identified healthcare products may be identified as candidates for reimbursement valuation based on the filtering and selection processing performed at block 204.

At block 206, valuation processing may be performed to determine a value indicative of an increase in total reimbursements associated with the candidate healthcare product. The valuation processing may be performed responsive to execution by the processor(s) 112 of the computer-executable instructions provided as part of the valuation engine 124. The valuation processing performed at block 206 will be described in more detail through reference to the illustrative method depicted in FIG. 3.

FIG. 3 is a process flow diagram of an illustrative method 300 for determining whether a healthcare product associated with an increased reimbursement parameter is a candidate for reimbursement valuation and for performing processing associated with the reimbursement valuation in accordance with one or more embodiments of the disclosure. According to one or more embodiments of the disclosure, the functionality for performing one or more of the operations of the illustrative method 300 may be supported by the reimbursement valuation computer 102, or more specifically, the reimbursement valuation application 120 or sub-modules included therein such as the filtering and selection engine 122 and/or the valuation engine 124.

At block 302, one or more healthcare products associated with an increase in a reimbursement parameter from a first rate to a second rate may be identified. Computer-executable instructions provided as part of the filtering and selection engine 122 may be executed to analyze reimbursement review data retrieved from the datastore(s) 136 to identify the one or more healthcare products. The reimbursement parameter that has been increased may be a MAC rate associated with the healthcare product. While the illustrative method 300 may be described hereinafter primarily through reference to an increase in the MAC rate, it should be appreciated that a healthcare product may be identified at block 302 based on an increase in any suitable reimbursement parameter or initiation of reimbursement in accordance with an alternate reimbursement parameter. For example, in one or more alternate embodiments, one or more of the healthcare products identified at block 302 may be associated with a decision by a claims processor to cease reimbursement at a MAC rate and initiate reimbursement in accordance with another reimbursement parameter (e.g., a contracted rate). The identification of the healthcare product(s) may be based at least in part on at least a portion of the valuation timeframe data 126 as described earlier.

Blocks 304-338 may form at least part of an iterative process performed on each of the healthcare products identified at block 302 to determine if the healthcare product is a candidate for reimbursement valuation, and if so determined, to calculate a value indicative of total increased reimbursements for the candidate healthcare product. The operations of blocks 304-338 may be performed responsive to the execution of computer-executable instructions provided as part of the filtering and selection engine 122 and/or the valuation engine 124. For example, the operations of blocks 304-326 may be performed, at least in part, responsive to the execution of computer-executable instructions provided as part of the filtering and selection engine 122 and the operations of blocks 328-338 may be performed, at least in part, responsive to the execution of computer-executable instructions provided as part of the valuation engine 124.

At block 304, a previously unselected healthcare product from among those identified at block 302 may be selected. At block 306, a first set of healthcare transactions associated with a designated time period prior to a time frame associated with the increase in the reimbursement parameter may be identified. For example, the filtering and selection engine 122 may be configured to access healthcare claim transaction data stored in the datastore(s) 136 and parse or otherwise analyze the data to identify the first set of healthcare claim transactions. The designated time period may be identified based at least in part on at least a portion of the valuation timeframe data 126 and/or based at least in part on user input.

At block 308, a second set of healthcare transactions associated with a designated time period subsequent to the time frame associated with the increase in the reimbursement parameter may be identified. For example, the filtering and selection engine 122 may be configured to access healthcare claim transaction data stored in the datastore(s) 136 and parse or otherwise analyze the data to identify the second set of healthcare claim transactions. The designated time period may be identified based at least in part on at least a portion of the valuation timeframe data 126 and/or based at least in part on user input. The designated time period based on which the first set of transactions is identified and the designated time period based on which the second set of transactions is identified may be of a same or different duration.

At block 310, a first subset of healthcare claim transaction(s) reimbursed below cost may be identified from the first set. The first subset may include healthcare claim transactions reimbursed at a MAC rate below cost and/or claim transactions reimbursed in accordance with alternative reimbursement parameters (e.g., a Usual and Customary rate, an Ingredient Cost Submitted Rate, a contracted rate, etc.). Accordingly, at block 312, any healthcare transaction(s) in the first subset that were reimbursed in accordance with a reimbursement parameter other than the MAC rate, such as any of the illustrative reimbursement parameters described above, may be filtered from the first subset. It may then be assumed that any healthcare transaction(s) remaining in the first subset subsequent to the operation at block 312 will have been reimbursed at a MAC rate below cost.

At block 314, a determination may be made as to whether any healthcare transaction(s) remain in the first subset subsequent to the filtering operation of block 312. If it is determined at block 314 that no healthcare transactions remain in the first subset, the method 300 may proceed to block 316. The operations of blocks 316-322 describe processing that may be performed responsive to a determination that no healthcare claim transactions remain in the first subset.

At block 316, a determination may be made as to whether the second set includes any healthcare transaction(s) reimbursed in accordance with the second rate (e.g., the increased rate for the reimbursement parameter). In certain embodiments, the reimbursement parameter may correspond to a MAC rate associated with the selected healthcare product, and the second rate may correspond to an increase in the MAC rate associated with the healthcare product. If it is determined at block 316 that no healthcare transactions in the second set were reimbursed in accordance with the second rate, the method 300 may proceed to block 318 where a determination may be made that the selected healthcare product is not a candidate for reimbursement valuation. This determination may be based, at least in part, on the fact that the first set of healthcare transactions includes no transactions reimbursed below cost in accordance with the first rate of the reimbursement parameter (e.g., the previous MAC rate) and that the second set of healthcare transactions includes no transactions reimbursed in accordance with the second rate of the reimbursement parameter (e.g., the increased MAC rate). In such a scenario, it may prove difficult to generate a value indicative of an increase in total reimbursements as a result of the increase in the reimbursement parameter.

From block 318, the method 300 may proceed to block 320 where a determination may be made as to whether any identified healthcare product(s) have not been selected for performing the filtering and selection processing and/or the valuation processing. If it is determined that all identified healthcare products have been selected, the method 300 may end. On the other hand, if it is determined that previously unselected healthcare product(s) remain, the method 300 may again proceed to block 304 and a previously unselected healthcare product may be selected for performing filtering and selection processing and/or valuation processing.

Referring again to the determination at block 316, if it is determined that the second set includes any healthcare transaction(s) reimbursed in accordance with the second rate for the reimbursement parameter (e.g., the increased MAC rate), the method 300 may proceed to block 322. At block 322, a reimbursement amount associated with a representative healthcare transaction may be selected as the first rate for use in connection with the valuation processing performed at later stages of the method 300. The representative healthcare transaction may be a transaction reimbursement at a reimbursement rate below cost and which was previously identified as being a suitable (or most suitable) candidate for requesting an increase in a reimbursement parameter (e.g., the MAC rate) associated with the healthcare product. The operation performed at block 322 may arise, for example, in scenarios in which there is a shortage of the healthcare product that may not have been resolved until the time frame associated with the increase in the reimbursement parameter or subsequent thereto. Accordingly, in the case of a shortage, the first subset may not include any transactions reimbursed below cost in accordance with the first rate of the reimbursement parameter but the second set may include transactions reimbursed in accordance with the increased second rate. The method 300 may then proceed to block 324.

The method 300 may also proceed to block 324 upon a determination at block 314 that the first subset includes healthcare transaction(s) reimbursed below cost in accordance with the first rate of the reimbursement parameter (e.g., the MAC rate prior to the increase) and that the second set includes healthcare transaction(s) reimbursed in accordance with the increased second rate (e.g., the increased MAC rate). Although the method 300 is depicted as proceeding from block 314 to block 324, in various embodiments, one or more intermediary determinations may be made.

For example, in certain embodiments, a determination may first be made as to whether the number of healthcare transaction(s) in the first subset that were reimbursed in accordance with the first rate of the reimbursement parameter satisfies a desired threshold. The threshold may be identified, for example, based at least in part on at least a portion of the valuation threshold data 128. If it is determined that the threshold is not met, it may be assumed that below cost reimbursement was not widespread prior to the increase in the reimbursement parameter, and it may be determined that the healthcare product is not a candidate for reimbursement valuation. In such a scenario, the method may then proceed to block 320.

On the other hand, if it is determined that the number of healthcare transactions included in the first subset does satisfy an associated threshold, the method 300 may proceed to block 324 where a determination may be made as to whether the second set includes any healthcare transaction(s) reimbursed at a rate that is not in accordance with the second rate. If it is determined that the second set includes any such transaction(s) reimbursed at a rate that is not in accordance with the second rate, the method 300 may proceed to block 326 where such transactions may be filtered out of the second set. Upon filtering such transaction from the second set, the method 300 may proceed to block 328. Further, if it is determined that the second set includes no transaction(s) reimbursed at a rate that is not in accordance with the second rate, the method 300 may proceed from block 324 to block 328.

A variety of factors may result in healthcare transaction(s) in the second set being reimbursed at rates other than the second rate. For example, the increase in the reimbursement parameter may only be associated with a particular geographic region, in which case, healthcare transactions that are associated with other geographic regions may be continue to be reimbursed at a previous rate (e.g., a previous MAC rate for the geographic region). As another non-limiting example, in response to a request to increase a reimbursement rate associated with a reimbursement parameter (e.g., a MAC rate), rather than increasing the rate associated with the parameter, the claims processor may instead cease reimbursements in accordance with the reimbursement parameter and initiate reimbursements in accordance with an alternate parameter (e.g., a contracted rate). It should be appreciated that numerous other reasons may exist for healthcare transaction(s) in the second set being reimbursed at a rate that is not in accordance with the increased rate for the reimbursement parameter (e.g., the second rate).

At block 328, a metric indicative of a per-unit reimbursement amount may be determined for the healthcare transaction(s) in the first subset. The metric may be, for example, an average of the per-unit reimbursement amounts for the transaction(s) in the first subset (e.g., the transactions determined to be reimbursed at a MAC rate below cost during a time period prior to the increase in the MAC rate). In those embodiments in which the first subset does not include any transactions reimbursed below cost at the pre-increase reimbursement rate associated with the reimbursement parameter, and the second set includes transaction(s) reimbursed in accordance with the increased reimbursement rate for the reimbursement parameter, the metric may correspond to a reimbursement amount associated with a representative healthcare transaction submitted in connection with a request for a reimbursement rate increase, as described earlier. From block 328, the method 300 may proceed to block 330.

Blocks 330-338 correspond to operations performed as part of an iterative process forming at least part of the valuation processing according to embodiments of the disclosure. At block 330, a previously unselected healthcare transaction may be selected from the second set. At block 332, the metric indicative of a per-unit reimbursement amount associated with the transaction(s) in the first subset may be subtracted from a per-unit reimbursement amount associated with the selected healthcare transaction (e.g., an increased MAC rate reimbursement per unit of healthcare product dispensed) in order to generate a value indicative of a per-unit reimbursement increase for the selected transaction.

At block 334, the per-unit reimbursement increase may be multiplied by the number of units of the healthcare product dispensed in connection with the selected healthcare transaction in order to generate a value indicative of the total increased reimbursement for the selected transaction. Upon determining the value indicative of the total increased reimbursement for the selected transaction, the method 300 may proceed to block 336.

At block 336, a determination may be made as to whether any healthcare transaction(s) in the second set have not been selected for valuation processing. If it is determined that all valuation processing has been performed for all transaction(s) in the second set, the method 300 may proceed to block 338 where each value indicative of the total reimbursement for a particular healthcare claim transaction in the second set may be summed to generate a value indicative of total increased reimbursement for the selected product. The method 300 may then proceed to block 320 for the determination as to whether any unselected healthcare product(s) remain. On the other hand, if it is determined that additional healthcare transaction(s) in the second set have not been selected for valuation processing, the method 300 may again proceed to block 330 where a previously unselected healthcare transaction from the second set may be selected for valuation processing.

The illustrative method 300 depicted in and described with respect to FIG. 3 may result in an identification of those healthcare product(s), among healthcare products identified as being associated with an increase in a reimbursement parameter, that are candidates for valuation processing based at least in part on various filtering and selection processing that may be performed, at least in part, responsive to the execution of computer-executable instructions provided as part of the filtering and selection engine 122. The illustrative method 300 further provides for performing valuation processing on the candidate healthcare product(s) to generate one or more values indicative of an increase in total reimbursements for the healthcare product resulting from the increase in the reimbursement rate associated with the reimbursement parameter. The valuation processing may be performed, at least in part, responsive to the execution of computer-executable instructions provided as part of the valuation engine 124.

FIG. 4 is a process flow diagram of an illustrative method for determining a total loss of additional reimbursement for a healthcare transaction reimbursed at an alternate rate subsequent to an increase in a reimbursement parameter associated with a healthcare product in accordance with one or more embodiments of the disclosure. According to one or more embodiments of the disclosure, the functionality for performing one or more of the operations of the illustrative method 400 may be supported by the reimbursement valuation computer 102, or more specifically, the reimbursement valuation application 120 or sub-modules included therein such as the filtering and selection engine 122 and/or the valuation engine 124.

At block 402, any healthcare transaction(s) reimbursed at a Usual and Customary rate may be identified from the second set of healthcare transactions described earlier through reference to FIG. 3. From block 402, the method 400 may proceed to block 404.

Blocks 404-410 may represent an iterative process for generating one or more values indicative of additional reimbursement loss due to reimbursement at a Usual and Customary rate. At block 404, a previously unselected healthcare transaction reimbursed at the Usual and Customary rate may be selected from those transactions identified at block 402.

At block 406, a per-unit Usual and Customary rate associated with the selected transaction may be subtracted from the increased reimbursement rate associated with at least one healthcare transaction in second set that was not reimbursed at the Usual and Customary rate in order to generate a value indicative of a per-unit loss of additional reimbursement associated with the selected transaction. The increased reimbursement rate may correspond, for example, to an increase in the MAC rate for the healthcare product to which the second set of healthcare transactions relates.

At block 408, the value indicative of the per-unit loss of additional reimbursement generated at block 406 may be multiplied by the number of dispensed units to generate a value indicative of the total loss of additional reimbursement associated with the selected transaction due to reimbursement at the Usual and Customary rate rather than the increased reimbursement parameter rate (e.g., the increased MAC rate).

At block 410, a determination may be made as to whether any healthcare transaction(s) identified at block 402 have not been selected for a determination of total loss of additional reimbursement due to reimbursement at the Usual and Customary rate. If it is determined that unselected healthcare transaction(s) remain, the method 400 may proceed to block 404 where a previously unselected transaction may be selected for determination of total loss additional reimbursement. On the other hand, if it is determined that the processing of blocks 404-408 has been performed for all transaction(s) identified as being reimbursed at the Usual and Customary rate, the method 400 may end.

The operations described and depicted in the illustrative methods 200, 300, and 400 of FIGS. 2-4 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 2-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described for performing filtering and/or selection processing in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method, comprising:
identifying, by a reimbursement valuation system comprising one or more computers, a healthcare product from a plurality of healthcare products;
determining, by the reimbursement valuation system, that the healthcare product is a candidate healthcare product for reimbursement valuation, wherein determining that the healthcare product is a candidate healthcare product comprises:
determining, by the reimbursement valuation system and based at least in part on healthcare claim transaction data, that the candidate healthcare product is associated with one or more first healthcare claim transactions and one or more second healthcare claim transactions, wherein each of the one or more first healthcare claim transactions is associated with a first reimbursement amount and each of the one or more second healthcare transactions is associated with a respective second reimbursement amount, wherein each respective second reimbursement amount is greater than the first reimbursement amount; and
determining, by the reimbursement valuation system, a value indicative of an increase in total reimbursements associated with the candidate healthcare product based at least in part on the first reimbursement amount and each respective second reimbursement amount.

2. The method of claim 1, wherein the identifying a healthcare product from a plurality of healthcare products comprises:
determining, by the reimbursement valuation system, that a reimbursement parameter associated with the healthcare product has been increased from a first reimbursement rate to a second reimbursement rate,
wherein the first reimbursement amount corresponds to the first reimbursement rate and each respective second reimbursement amount corresponds to the second reimbursement rate.

3. The method of claim 1, wherein the determining a value indicative of an increase in total reimbursements associated with the candidate healthcare product comprises:
determining, by the reimbursement valuation system, a set of reimbursement values, wherein each reimbursement value in the set of reimbursement values is indicative of an increase in reimbursement associated with a respective one of the plurality of second healthcare transactions, and wherein each reimbursement value corresponds to a difference between the respective second reimbursement amount associated with the respective one of the plurality of second healthcare claim transactions and the first reimbursement amount; and
aggregating the reimbursement values to generate the value indicative of an increase in total reimbursements.

4. The method of claim 3, wherein each reimbursement value is indicative of an increase in reimbursement per unit of the candidate healthcare product dispensed in association with the respective one of the plurality of second healthcare claim transactions, and wherein aggregating the reimbursement values comprises:
summing the reimbursement values to generate a reimbursement sum; and
multiplying the reimbursement sum by a total number of units of the healthcare product dispensed in association with the plurality of second healthcare claim transactions.

5. The method of claim 1, wherein the first reimbursement amount is an average of respective reimbursement amounts associated with the plurality of first healthcare claim transactions.

6. The method of claim 1, further comprising:
determining, by the reimbursement valuation system, a time associated with an increase in a value of a reimbursement parameter associated with the candidate healthcare product,
wherein the one or more first healthcare claim transactions are associated with a first predetermined period of time prior to the time associated with the increase in the value of the reimbursement parameter, and
the one or more second healthcare transactions are associated with a second predetermined period of time subsequent to the time associated with the increase in the value of the reimbursement parameter.

7. The method of claim 6, wherein the first predetermined period of time and the second predetermined period of time have a same duration.

8. The method of claim 1, wherein each respective second reimbursement amount corresponds to a respective one of:
(i) an increased Maximum Allowable Cost associated with the candidate healthcare product, or
(ii) a contracted rate for the candidate healthcare product.

9. The method of claim 1, wherein the candidate healthcare product is a first healthcare product, further comprising:
identifying, by the reimbursement valuation system, a second healthcare product from the plurality of healthcare products; and
determining, by the reimbursement valuation system, that the second healthcare product is not a candidate for reimbursement valuation.

10. The method of claim 9, wherein the determining that the second healthcare product is not a candidate for reimbursement valuation comprises:
determining, by the reimbursement valuation system, that a reimbursement parameter associated with the second healthcare product has been increased from a first value to a second value;
determining, by the reimbursement valuation system, a time associated with the increase in the reimbursement parameter from the first value to the second value;
identifying, by the reimbursement valuation system, a period of time subsequent to the time associated with the increase in the reimbursement parameter; and
determining, by the reimbursement valuation system, that the healthcare claim transaction data does not include data relating to any healthcare claim transaction reimbursed at the second value and that is associated with the second healthcare product and the period of time.

11. The method of claim 9, wherein the determining that the second healthcare product is not a candidate for reimbursement valuation comprises:
determining, by the reimbursement valuation system, that a reimbursement parameter associated with the second healthcare product has been increased from a first value to a second value;
determining, by the reimbursement valuation system, a time associated with the increase in the reimbursement parameter from the first value to the second value;
identifying, by the reimbursement valuation system, a period of time prior to the time associated with the increase in the reimbursement parameter; and
determining, by the reimbursement valuation system and based at least in part on the healthcare claim transaction data, that a number of healthcare claim transactions that were reimbursed at the first value and that are associated with the second healthcare product and with the period of time is less than a threshold number.

12. A system, comprising:
at least one memory storing computer-executable instructions; and
at least one processor configured to access the at least one memory and execute the computer-executable instructions to:
identify a healthcare product from a plurality of healthcare products;
determine that the healthcare product is a candidate healthcare product for reimbursement valuation, wherein determining that the healthcare product is a candidate healthcare product comprises:
determining, based at least in part on healthcare claim transaction data, that the candidate healthcare product is associated with one or more first healthcare claim transactions and one or more second healthcare claim transactions, wherein each of the one or more first healthcare claim transactions is associated with a first reimbursement amount and each of the one or more second healthcare transactions is associated with a respective second reimbursement amount, wherein each respective second reimbursement amount is greater than the first reimbursement amount; and
determining a value indicative of an increase in total reimbursements associated with the candidate healthcare product based at least in part on the first reimbursement amount and each respective second reimbursement amount.

13. The system of claim 12, wherein, to identify a healthcare product from a plurality of healthcare products, the at least one processor is configured to execute the computer-executable instructions to:
determine that a reimbursement parameter associated with the healthcare product has been increased from a first reimbursement rate to a second reimbursement rate,
wherein the first reimbursement amount corresponds to the first reimbursement rate and each respective second reimbursement amount corresponds to the second reimbursement rate.

14. The method of claim 12, wherein, to determine a value indicative of an increase in total reimbursements associated with the candidate healthcare product, the at least one processor is configured to execute the computer-executable instructions to:
determine a set of reimbursement values, wherein each reimbursement value in the set of reimbursement values is indicative of an increase in reimbursement associated with a respective one of the plurality of second healthcare transactions, and wherein each reimbursement value corresponds to a difference between the respective second reimbursement amount associated with the respective one of the plurality of second healthcare claim transactions and the first reimbursement amount; and
aggregate the reimbursement values to generate the value indicative of an increase in total reimbursements.

15. The system of claim 14, wherein each reimbursement value is indicative of an increase in reimbursement per unit of the candidate healthcare product dispensed in association with the respective one of the plurality of second healthcare claim transactions, and wherein, to aggregate the reimbursement values, the at least one processor is configured to execute the computer-executable instructions to:
sum the reimbursement values to generate a reimbursement sum; and
multiply the reimbursement sum by a total number of units of the healthcare product dispensed in association with the plurality of second healthcare claim transactions.

16. The system of claim 12, wherein the first reimbursement amount is an average of respective reimbursement amounts associated with the plurality of first healthcare claim transactions.

17. The system of claim 12, wherein the at least one processor is further configured to execute the computer-executable instructions to:
determine a time associated with an increase in a value of a reimbursement parameter associated with the candidate healthcare product,
wherein the one or more first healthcare claim transactions are associated with a first predetermined period of time prior to the time associated with the increase in the value of the reimbursement parameter, and
the one or more second healthcare transactions are associated with a second predetermined period of time subsequent to the time associated with the increase in the value of the reimbursement parameter.

18. The system of claim 12, wherein each respective second reimbursement amount corresponds to a respective one of:
(i) an increased Maximum Allowable Cost associated with the candidate healthcare product, or
(ii) a contracted rate for the candidate healthcare product.

19. The system of claim 12, wherein the candidate healthcare product is a first healthcare product, further comprising:
identifying, by the reimbursement valuation system, a second healthcare product from the plurality of healthcare products; and
determining, by the reimbursement valuation system, that the second healthcare product is not a candidate for reimbursement valuation.

20. The system of claim 12, wherein the at least one processor is further configured to execute the computer-executable instructions to:
determine a value indicative of loss of additional reimbursements associated with the candidate healthcare product based at least in part on: (i) the respective second reimbursement amount associated with the candidate healthcare product and (ii) an increased reimbursement amount associated with a reimbursement parameter associated with the candidate healthcare product.

21. The system of claim 20, wherein the respective second reimbursement amount associated with the candidate healthcare product corresponds to a Usual and Customary rate, and wherein the reimbursement parameter corresponds to a Maximum Allowable Cost rate.

22. One or more computer-readable media storing computer-executable instructions that responsive to execution cause operations to be performed comprising:
identifying a healthcare product from a plurality of healthcare products;
determining that the healthcare product is a candidate healthcare product for reimbursement valuation, wherein determining that the healthcare product is a candidate healthcare product comprises:
determining, based at least in part on healthcare claim transaction data, that the candidate healthcare product is associated with one or more first healthcare claim transactions and one or more second healthcare claim transactions, wherein each of the one or more first healthcare claim transactions is associated with a first reimbursement amount and each of the one or more second healthcare transactions is associated with a respective second reimbursement amount, wherein each respective second reimbursement amount is greater than the first reimbursement amount; and
determining a value indicative of an increase in total reimbursements associated with the candidate healthcare product based at least in part on the first reimbursement amount and each respective second reimbursement amount.
